(19) United States
(12) Patent Application Publication
(10) Pub. No.: US 2013/0322650 A1
(43) Pub. Date: Dec. 5, 2013

(54) NOISE ELIMINATION CIRCUIT FOR AUDIO EQUIPMENT

(71) Applicants: HONG FU JIN PRECISION INDUSTRY (WuHan) CO., LTD., (US); HON HAI PRECISION INDUSTRY CO., LTD., New Taipei (TW)

(72) Inventor: LI-YONG WANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/786,369

(22) Filed: Mar. 5, 2013

(30) Foreign Application Priority Data
May 31, 2012 (CN) 201210175162.X

(51) Int. Cl. H04R 3/02

(52) U.S. Cl. CPC H04R 3/02
USPC 381/94.5

(57) ABSTRACT

A noise elimination circuit of a computer includes a switch and a converting chip. The switch includes first, second, and third electrodes. The first electrode is connected to a control terminal and the third electrode is connected to a first voltage source. The converting chip includes an input pin and an output pin. The input pin is connected to a second voltage source. The output pin is connected to a control chip that controls a speaker. The output pin is connected to the second electrode. The second voltage source powers on the input pin when the computer is triggered to be powered on and powers off the input pin when the computer is triggered to be powered off. The control terminal sends a control signal to the first electrode to actuate the switch, after the computer is triggered and before the second voltage source powers on the input pin.

### BACKGROUND

1. Technical Field

The present disclosure relates to noise elimination circuits, more particularly to a noise elimination circuit for eliminating the noise from audio equipment.

2. Description of Related Art

Multimedia audio equipment generally includes a sound card located on a motherboard and an audio output device such as a loudspeaker. The sound card and the audio output device are mounted in an electronic device which needs to output sound. However, when the electronic device is shut down, the sound card usually generates an analog output. The analog output is transmitted to the loudspeaker to generate an audible pop.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a noise elimination circuit in accordance with one embodiment of the present disclosure.

FIG. 2 is a circuit diagram of the noise elimination circuit of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

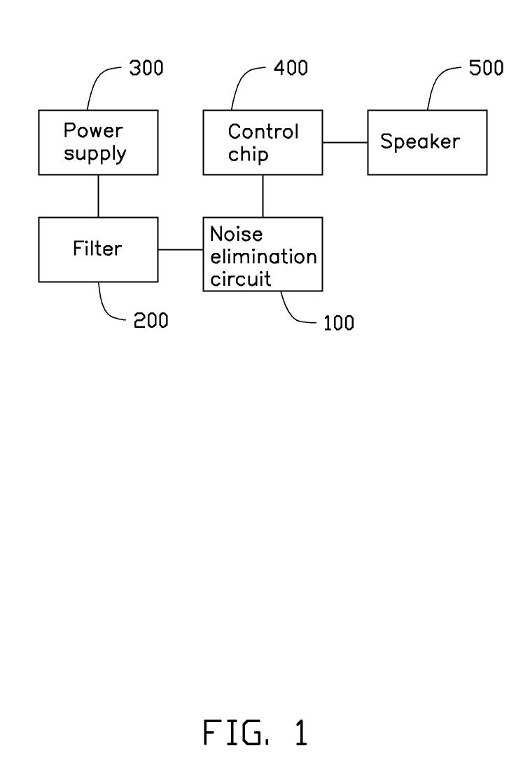

FIG. 1 is a noise elimination circuit 100 for a computer in accordance with one embodiment. The noise elimination circuit 100 is connected to a voltage source via a filter 200. The noise elimination circuit 100 is connected to a speaker 500 via a control chip 400. In one embodiment, the control chip 400 is a RealtecAC97 chip, and the voltage source is a power supply 300.

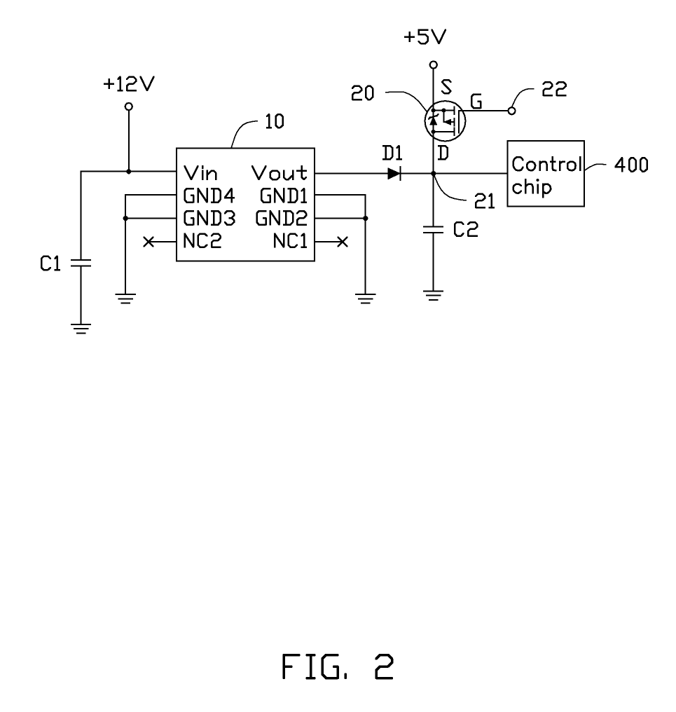

FIG. 2 shows the noise elimination circuit 100 includes a converting chip 10 and a switch 20. In one embodiment, the converting chip 10 is a MC78L05ACDR2G chip, and the switch 20 is a field effect transistor.

The input pin Vin of the converting chip 10 is connected to the filter 200. The input pin Vin of the converting chip 10 is connected to ground via a capacitor C1. The output pin Vout of the converting chip 10 is connected to a positive terminal of a diode D1. A negative terminal of the diode D1 is connected to a node 21. The node 21 is connected to ground via a capacitor C2. The node 21 is connected to a drain electrode D of the switch 20. The ground pins GND1, GND2, GND3, GND4 of the converting chip 10 is connected to ground. A grid electrode G of the switch 20 is connected to a control terminal 22. A source electrode S of the switch is connected to a +5V voltage source.

In use, the computer is triggered to be powered on. The control terminal 22 sends a low level control signal to the grid electrode G of the switch 20 to actuate the switch 20 before the power supply 300 sends out +12V. The +5V voltage source powers on the control chip 400 which powers on the speaker 500. The power supply 300 sends out +12V to the converting chip 10 via the filter 200. The converting chip 10 converts +12V to +5V and sends +5V, (the voltage of the output pin Vout is +5V). The output pin Vout supplies power to the control chip 400. Then the control terminal 22 sends a high level control signal to the grid electrode G of the switch 20 to switch off the switch 20 to avoid the speaker 500 from generating an audible pop.

When the computer is triggered to be powered off, the control terminal 22 sends a low level control signal to the grid electrode G of the switch 20 to power on the switch 20 before the power supply is powered off. The +5V voltage source powers on the control chip 400. When the power supply 300 is powered off, the voltage of the output pin Vout is 0V, and the control terminal 22 sends a high level control signal to the grid electrode G of the switch 20 to switch off the switch 20 to enable the speaker 500 to avoid generating an audible pop.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A noise elimination circuit of a computer, comprising:
a switch, the switch comprising a first electrode, a second electrode, and a third electrode; the first electrode is connected to a control terminal; and the third electrode is connected to a first voltage source; and
a converting chip, the converting chip comprises an input pin and an output pin; the input pin is configured to be connected to a second voltage source; the output pin is connected to a node; the node is configured to be connected to a control chip that controls a speaker; the node is connected to the second electrode of the switch; the second voltage source is configured to power on the input pin when the computer is triggered to be powered on and power off the input pin when the computer is triggered to be powered off;
wherein the control terminal is configured to send a first control signal to the first electrode to actuate the switch, after the computer is triggered to be powered on and before the second voltage source powers on the input pin, thereby enabling the first voltage source to power on the node; and the control terminal is further configured to send a second control signal to the first electrode to actuate the switch, after the computer is triggered to be powered off and before the second voltage source powers on the input pin, thereby enabling the first voltage source to power on the node.

2. The noise elimination circuit of claim 1, wherein the control terminal is further configured to send a third control signal to the first electrode to switch off the switch after the second voltage source powers on the input pin.

3. The noise elimination circuit of claim 1, wherein the control terminal is further configured to send a fourth control signal to the first electrode to switch off the switch after the second voltage source powers off the input pin.

4. The noise elimination circuit of claim 1, wherein the output pin is connected to the node via a diode; a positive terminal of the diode is connected to the output pin; and the negative terminal of the diode is connected to the node.

5. The noise elimination circuit of claim 1, wherein the node is connected to ground via a capacitor.

6. The noise elimination circuit of claim 1, wherein the input pin is connected to ground via a capacitor.

7. The noise elimination circuit of claim 1, wherein the switch is a field effect transistor;
the first electrode is a grid electrode of the field effect transistor; the second electrode is a drain electrode of the field effect transistor; and the third electrode is a source electrode of the field effect transistor.

8. The noise elimination circuit of claim 1, wherein the first control signal and the second control signal are low level.
